(19) United States
(12) Patent Application Publication
(10) Pub. No.: US 2022/0063394 A1
(43) Pub. Date: Mar. 3, 2022

(54) COOLING APPARATUS FOR HYBRID VEHICLE

(71) Applicant: HONDA MOTOR CO., LTD., Tokyo (JP)

(72) Inventors: Hajime UTO, Saitama-ken (JP); Masanobu TAKAZAWA, Saitama-ken (JP); Masayuki TOYOKAWA, Saitama-ken (JP); Naoaki TAKEDA, Saitama-ken (JP)

(21) Appl. No.: 17/424,264

(22) PCT Filed: Jan. 21, 2019
(86) PCT No.: PCT/JP2019/001611

§ 371 Date: Jul. 20, 2021

(51) Int. Cl. B60K 11/04; H02K 7/00; H02K 9/19; H02K 11/25

(52) U.S. Cl. CPC B60K 11/04; H02K 11/25; H02K 9/19; H02K 7/006

(57) ABSTRACT

Provided is a cooling apparatus for a hybrid vehicle, the cooling apparatus enabling effective heat exchange between coolant of an engine cooling circuit and refrigerant of an electric-system cooling circuit, and enabling an internal combustion engine and an electric-system device to be cooled and raised in temperature appropriately and speedily. A cooling apparatus 1 for a hybrid vehicle includes: an engine cooling circuit 3 configured to circulate coolant; an electric-system cooling circuit 6 configured to circulate refrigerant; and a heat exchanger 7 configured to perform heat exchange between the coolant and the refrigerant, in which the engine cooling circuit 3 includes: a main circuit 11 enabling continuous circulation of the coolant through the main circuit 11; a radiator circuit 12 configured to circulate the coolant between an internal combustion engine 2 and a radiator 8; a heat-exchange-coolant throughflow portion 13 enabling the coolant to flow through the heat-exchange-coolant throughflow portion 13 and configured to return the coolant having flowed out through the heat exchanger 7 to the main circuit 11; and a three-way valve 14 provided at an upstream end of the heat-exchange-coolant throughflow portion 13, the three-way valve 14 being capable of switching a flow path of the coolant such that the coolant having flowed out of either the internal combustion engine 2 or the radiator 8 is allowed to flow into the heat exchanger 7.

### TECHNICAL FIELD

The present invention relates to a cooling apparatus for a hybrid vehicle equipped with an internal combustion engine and a motor as drive sources, the cooling apparatus enabling heat exchange between an engine cooling circuit for cooling the internal combustion engine and an electric-system cooling circuit for cooling an electric-system device such as the motor, a generator, and a battery.

### BACKGROUND ART

A known cooling apparatus as this type is described in Patent Literature 1, for example. This cooling apparatus includes an engine cooling circuit that circulates coolant for cooling an internal combustion engine, an electric-system cooling circuit that circulates oil for cooling an electric-system device such as a motor, a heat exchanger that performs heat exchange between the coolant and the refrigerant of both circuits, and the like. In the engine cooling circuit, a water pump and a radiator are disposed in order downstream of the internal combustion engine, and the heat exchanger is disposed downstream of the radiator and upstream of the internal combustion engine. Thus, due to operation of the water pump, the coolant having flowed out of the internal combustion engine circulates such that the coolant having flowed out of the internal combustion engine passes the radiator and the heat exchanger in order and flows into the internal combustion engine.

Meanwhile, in the electric-system cooling circuit, an oil pump and a generator are disposed in order downstream of the motor, and a bypass passage are disposed between the oil pump and the generator such that the bypass passage passes in the heat exchanger. The electric-system cooling circuit is also provided with a flow-rate regulating valve for regulating the flow rate of the oil flowing into the heat exchanger side, at the upstream end of the bypass passage.

In the cooling apparatus having a configuration as above, in order to cool the oil of the electric-system cooling circuit, the opening degree of the flow-rate regulating valve is increased and the flow rate of the oil flowing into the heat exchanger through the bypass passage is increased. Thus, in the heat exchanger, a large quantity of heat of the oil is deprived by the coolant of the engine cooling circuit. As a result, the oil is cooled and the temperature of the coolant rises. In contrast, in order to cool the coolant of the engine cooling circuit, the opening degree of the flow-rate regulating valve is reduced and the flow rate of the oil flowing into the heat exchanger through the bypass passage is reduced. Thus, the quantity of heat received by the coolant from the oil decreases. As a result, the temperature rise of the coolant having been cooled in the radiator is suppressed and the cooling of the coolant is secured.

### CITATION LIST

### Patent Literature

Patent Literature 1: JP 2007-69829 A

### SUMMARY OF INVENTION

### Technical Problem

A vehicle provided with the above cooling apparatus has the following issues. That is, for example, during traveling of a hybrid vehicle with the motor driving and the internal combustion engine stopped, when the internal combustion engine is driven in response to a drive command from the control device of the vehicle, if the internal combustion engine is operated under a high load before warm-up, the fuel consumption may be reduced and the exhaust characteristics may be deteriorated. In order to avoid this issue, it is necessary to warm up the internal combustion engine early. As described above, in the above cooling apparatus, in order to raise the temperature of the coolant of the engine cooling circuit, the flow rate of the oil flowing into the heat exchanger through the bypass passage of the electric-system cooling circuit is increased, thereby transferring the quantity of heat of the oil to the coolant of the engine cooling circuit. The heat exchanger, however, is disposed downstream of the radiator, so that it takes time to warm up the internal combustion engine even if the flow rate of the oil flowing through the bypass passage is increased.

In addition, a motor and a generator typically each have a temperature range for its efficient operation. Thus, in a case where the motor or the generator is operated, it is preferable to raise its temperature early when the temperature is lower than the above temperature range. In the above cooling apparatus, in order to raise the temperature of the motor or the generator, the opening degree of the flow-rate regulating valve is reduced to suppress the decrease in the temperature of the oil, the flow-rate regulating valve is closed to stop the flow of the oil, or the like in the electric-system cooling circuit. As a result, the motor or the generator can be raised in temperature. However, in a case where the motor or the generator needs to be operated having a temperature significantly lower than the predetermined range, it takes time to raise the temperature. Thus, the motor or the generator is operated inefficiently during raising its temperature.

The present invention has been made to solve such issues as above, and an object of the present invention is to provide a cooling apparatus for a hybrid vehicle, the cooling apparatus enabling effective heat exchange between coolant of an engine cooling circuit and refrigerant of an electric-system cooling circuit, and enabling an internal combustion engine and an electric-system device to be cooled and raised in temperature appropriately and speedily.

### Solution to Problem

In order to achieve the above object, the invention according to claim 1 is a cooling apparatus 1 for a hybrid vehicle, the cooling apparatus 1 including: an engine cooling circuit 3 configured to circulate coolant for cooling an internal combustion engine 2; an electric-system cooling circuit 6 configured to circulate refrigerant for cooling an electric-system device (a motor 4 and a generator 5 in an embodiment and hereinafter, the same in this claim); and a heat exchanger 7 configured to perform heat exchange between the coolant and the refrigerant each flowing through the heat exchanger 7, in which the engine cooling circuit includes: a main circuit 11 enabling continuous circulation of the coolant through the main circuit; a radiator circuit 12 including a radiator 8 for cooling the coolant and configured to circulate the coolant between the internal combustion engine and the radiator; a heat-exchange-coolant throughflow portion 13 having the heat exchanger, enabling the coolant to flow through the heat-exchange-coolant throughflow portion 13, and configured to return the coolant having flowed out through the heat exchanger to the main circuit; and a flow-path switch (three-way valve 14) provided at an upstream end of the heat-exchange-coolant throughflow portion, the flow-path switch being capable of switching a flow path of the coolant such that the coolant having flowed out of either the internal combustion engine or the radiator is allowed to flow into the heat exchanger.

According to this configuration, the coolant in circulation through the engine cooling circuit for cooling the internal combustion engine and the refrigerant in circulation through the electric-system cooling circuit for cooling the electric-system device flow through the heat exchanger, and heat is exchanged between the coolant and the refrigerant.

For example, in a case where the internal combustion engine and the coolant are lower in temperature while the electric-system device and the refrigerant is higher in temperature, when the internal combustion engine needs to be raised in temperature, the flow-path switch provided at the upstream end of the heat-exchange-coolant throughflow portion switches the flow path of the coolant such that the coolant having flowed out of the internal combustion engine is allowed to flow into the heat exchanger. Thus, in the heat exchanger, the heat of the refrigerant higher in temperature is transferred to the coolant. The coolant returns to the main circuit through the heat-exchange-coolant throughflow portion, flows into the internal combustion engine, and circulates. As a result, the temperature of the internal combustion engine can be raised speedily.

In a case opposite to the above, that is, in a case where the internal combustion engine and the coolant is higher in temperature while the electric-system device and the refrigerant are lower in temperature, when the electric-system device needs to be raised in temperature, the flow-path switch switches the flow path of the coolant similarly to the above case. That is, the flow path of the coolant is switched such that the coolant having flowed out of the internal combustion engine is allowed to flow into the heat exchanger. Thus, in the heat exchanger, the heat of the coolant higher in temperature is transferred to the refrigerant, and the refrigerant circulates through the electric-system cooling circuit. As a result, the temperature of the electric-system device can be raised speedily.

Furthermore, in a case where the electric-system device and the refrigerant are very higher in temperature, when the electric-system device needs to be cooled, the flow-path switch switches the flow path of the coolant such that the coolant having flowed out of the radiator is allowed to flow into the heat exchanger. Thus, in the heat exchanger, the heat of the refrigerant is deprived by the coolant lower in temperature having been cooled in the radiator, and the refrigerant circulates through the electric-system cooling circuit. As a result, the electric-system device can be cooled speedily.

As described above, according to the present invention, the flow-path switch causes the coolant having flowed out of either the internal combustion engine or the radiator to flow into the heat exchanger. As a result, heat can be effectively exchanged between the coolant of the engine cooling circuit and the refrigerant of the electric-system cooling circuit, and the internal combustion engine and the electric-system device can be cooled and raised in temperature appropriately and speedily.

According to the invention of claim 2, in the cooling apparatus for a hybrid vehicle described in claim 1, the flow-path switch is capable of switching the flow path of the coolant such that the coolant having flowed out of each of the internal combustion engine and the radiator is blocked from flowing into the heat exchanger.

According to this configuration, in a case where the flow-path switch switches the flow path of the coolant to block the coolant having flowed out of the internal combustion engine and the radiator from flowing into the heat exchanger, no heat is exchanged between the coolant of the engine cooling circuit and the refrigerant of the electric-system cooling circuit. For example, when the temperature of the refrigerant is not less than the lower limit within the temperature range for efficient operation of the electric-system device and is not in a sufficient state of actively raising the temperature of the electric-system device, the refrigerant circulates through the electric-system cooling circuit without being subject to heat exchange between the refrigerant and the coolant. As a result, when the electric-system device is in operation, the temperature of the electric-system device can be raised due to heat generation by itself, together with the temperature of the refrigerant in circulation.

According to the invention of claim 3, in the cooling apparatus for a hybrid vehicle described in claim 2, the flow-path switch includes a three-way valve 14 capable of selectively connecting any two ends of a downstream end of a first flow path (engine coolant flow path 2a) through which the coolant having flowed out of the internal combustion engine flows, a downstream end of a second flow path (fourth flow path 12d of the radiator circuit 12) through which the coolant having flowed out of the radiator flows, and the upstream end of the heat-exchange-coolant throughflow portion (first flow path 13a of the heat-exchange-coolant throughflow portion 13).

According to this configuration, the flow-path switch includes the three-way valve, and this three-way valve can selectively connect any two ends of the downstream end of the first flow path, the downstream end of the second flow path, and the upstream end of the heat-exchange-coolant throughflow portion. For example, in a case where the downstream end of the first flow path or the downstream end of the second flow path and the upstream end of the heat-exchange-coolant throughflow portion are connected together, the function and effect according to claim 1 described above can be achieved easily. Alternatively, in a case where the downstream end of the first flow path and the downstream end of the second flow path are connected together, the function and effect according to claim 2 described above can be achieved easily.

According to the invention of claim 4, in the cooling apparatus for a hybrid vehicle described in claim 3, further included are: a refrigerant temperature detection means (oil temperature sensor 27) for detecting a temperature of the refrigerant (oil temperature TATF) of the electric-system cooling circuit; and a three-way-valve control means (ECU 10a) for controlling the three-way valve, in which when the temperature of the refrigerant detected is higher than a predetermined first threshold TREF1 (TATF>TREF1), the three-way-valve control means controls the three-way valve such that the downstream end of the second flow path (fourth flow path 12d of the radiator circuit 12) and the upstream end of the heat-exchange-coolant throughflow portion (first flow path 13a of the heat-exchange-coolant throughflow portion 13) are connected together (Step 2: switching to mode B).

According to this configuration, when the temperature of the refrigerant of the electric-system cooling circuit is higher than the predetermined first threshold, the downstream end of the second flow path and the upstream end of the heat-exchange-coolant throughflow portion are connected together by the three-way valve. In this case, the coolant having flowed out of the radiator, that is, the coolant with the lowest temperature of the engine cooling circuit is introduced into the heat exchanger. As a result, the heat of the refrigerant having a relatively higher temperature is transferred to the coolant and the coolant flows into the radiator of the engine cooling circuit to be cooled. That is, the heat of the electric-system device that generates heat due to its operation can be discarded outside through the radiator of the engine cooling circuit. In addition, the refrigerant of the electric-system cooling circuit can be cooled with the radiator of the engine cooling circuit. Thus, a dedicated radiator or the like for cooling the refrigerant of the electric-system cooling circuit can be omitted.

According to the invention of claim 5, in the cooling apparatus for a hybrid vehicle described in claim 4, further included is: a coolant temperature detection means (engine coolant-temperature sensor 17) for detecting a temperature of the coolant of the engine cooling circuit (engine coolant temperature TW), in which when the temperature of the coolant detected is lower than the temperature of the refrigerant detected (TW<TATF), or when the temperature of the refrigerant is not more than the temperature of the coolant and is lower than a predetermined second threshold TREF2 smaller than the first threshold (TATF≤TW, TATF<TREF2), the three-way-valve control means controls the three-way valve such that the downstream end of the first flow path (engine coolant flow path 2a) and the upstream end of the heat-exchange-coolant throughflow portion (first flow path 13a of the heat-exchange-coolant throughflow portion 13) are connected together (Step 4: switching to mode A).

According to this configuration, when the temperature of the coolant of the engine cooling circuit is lower than the temperature of the refrigerant of the electric-system cooling circuit (herein after, referred to as “first temperature state” in Solution to Problem), or when the temperature of the refrigerant is not more than the temperature of the coolant and is lower than the predetermined second threshold smaller than the first threshold (hereinafter, referred to as “second temperature state” in Solution to Problem), the downstream end of the first flow path and the upstream end of the heat-exchange-coolant throughflow portion are connected together by the three-way valve. In this case, the coolant having flowed out of the internal combustion engine, that is, the coolant with the highest temperature of the engine cooling circuit is introduced into the heat exchanger.

In the first temperature state, the temperature of the refrigerant of the electric-system cooling circuit is higher than the temperature of the coolant of the engine cooling circuit. Thus, in the heat exchanger, the heat of the refrigerant is transferred to the coolant. As a result, the temperature of the coolant rises and the coolant circulates through the engine cooling circuit, and the internal combustion engine can be raised in temperature. Therefore, for example, when the internal combustion engine has not been warmed up yet, the internal combustion engine can be warmed up speedily. In contrast, in the second temperature state, when the temperature of the refrigerant of the electric-system cooling circuit is lower than the second threshold and the temperature of the coolant of the engine cooling circuit is higher than the temperature of the refrigerant of the electric-system cooling circuit, in the heat exchanger, the heat of the coolant is transferred to the refrigerant. Thus, the temperature of the refrigerant rises and the refrigerant circulates through the electric-system cooling circuit, so that the electric-system device can be raised in temperature. Therefore, for example, when the temperature of the electric-system device is lower than the temperature range for its efficient operation, the electric-system device can be raised in temperature speedily and operated efficiently.

According to the invention of claim 6, in the cooling apparatus for a hybrid vehicle described in claim 5, when the temperature of the refrigerant detected is not less than the second threshold (TATF≥TREF2), the three-way-valve control means controls the three-way valve such that the downstream end of the first flow path (engine coolant flow path 2a) and the downstream end of the second flow path (fourth flow path 12d of the radiator circuit 12) are connected together (Step 6: switching to mode C).

According to this configuration, when the temperature of the refrigerant of the electric-system cooling circuit is not less than the second threshold (hereinafter, referred to as “third temperature state” in Solution to Problem), the downstream end of the first flow path and the downstream end of the second flow path are connected together by the three-way valve. That is, neither the coolant having flowed out of the internal combustion engine nor the radiator is introduced into the heat exchanger, so that no heat is exchanged between the coolant and the refrigerant. In the third temperature state, when the temperature of the refrigerant is not in a sufficient state of actively raising the temperature of the electric-system device because the temperature of the refrigerant is not less than the second threshold, the refrigerant circulates through the electric-system cooling circuit without being subject to heat exchange between the refrigerant and the coolant similarly to claim 2 described above. As a result, the temperature of the electric-system device can be raised due to heat generation by itself, together with the temperature of the refrigerant in circulation.

According to the invention of claim 7, in the cooling apparatus for a hybrid vehicle described in any of claims 1 to 6, the electric-system device includes at least one of the motor 4 and the generator 5.

According to this configuration, the at least one of the motor and the generator as the electric-system device can be cooled by the refrigerant in circulation through the electric-system cooling circuit and can be raised in temperature as needed. Therefore, the respective temperatures of the motor and the generator are maintained within the predetermined temperature range, so that they can be operated efficiently.

### BRIEF DESCRIPTION OF DRAWINGS

FIG. 1 is a diagram schematically illustrating a cooling apparatus for a hybrid vehicle according to an embodiment of the present invention.

FIG. 2 is a block diagram of a control unit in the cooling apparatus of FIG. 1.

FIG. 3 is an explanatory diagram illustrating a switching state of a flow path of coolant by a three-way valve.

FIG. 4 is a flowchart illustrating coolant flow-path switching control by the three-way valve.

FIG. 5 is an explanatory diagram illustrating the flow of coolant of an engine cooling circuit and the flow of oil of an electric-system cooling circuit in the cooling apparatus for the hybrid vehicle, and illustrates that the flow of the coolant is stopped and only the oil is flowing.

FIG. 6 is an explanatory diagram similar to FIG. 5, and illustrates that the three-way valve is switched to mode B and coolant from a radiator is introduced into a heat exchanger.

FIG. 7 illustrates the flow of the coolant when a thermostat is open in the state of FIG. 6.

FIG. 8 is an explanatory diagram similar to FIG. 5, and illustrates that the three-way valve is switched to mode A and coolant from an engine is introduced into the heat exchanger.

FIG. 9 illustrates the flow of the coolant when the thermostat is open in the state of FIG. 8.

FIG. 10 is an explanatory diagram similar to FIG. 5, and illustrates that the three-way valve is switched to mode C and introduction of the coolant into the heat exchanger is blocked.

FIG. 11 illustrates the flow of the coolant when the thermostat is open in the state of FIG. 10.

### DESCRIPTION OF EMBODIMENTS

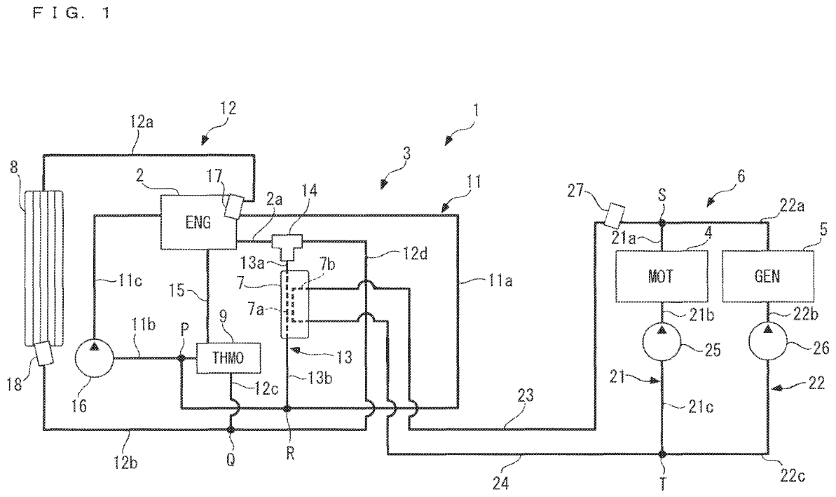

Hereinafter, a preferred embodiment of the present invention will be described in detail with reference to the drawings. FIG. 1 schematically illustrates a cooling apparatus according to an embodiment of the present invention. This cooling apparatus 1 is applied to a hybrid vehicle equipped with an internal combustion engine 2 and a motor 4 as drive sources.

As illustrated in FIG. 1, the cooling apparatus 1 includes an engine cooling circuit 3 that circulates coolant (for example, long life coolant (LLC)) for cooling the internal combustion engine 2 (hereinafter referred to as “engine”), an electric-system cooling circuit 6 that circulates oil (for example, automatic transmission fluid (ATF)) as refrigerant for cooling the motor 4 and a generator 5 as electric-system devices, a heat exchanger 7 for heat exchange between the coolant and the oil, and the like.

The engine cooling circuit 3 includes a main circuit 11 enabling continuous circulation of the coolant through the main circuit, a radiator circuit 12 that includes a radiator 8 for cooling the coolant due to dissipation to the outside and circulates the coolant between the engine 2 and the radiator 8, a heat-exchange-coolant throughflow portion 13 that has the heat exchanger 7 and returns the coolant having flowed out through the heat exchanger 7 to the main circuit 11, a three-way valve 14 (flow-path switch) that is provided at the upstream end of the heat-exchange-coolant throughflow portion 13 and switches a flow path of the coolant as described below, a bypass flow path 15 provided to connect the engine 2 and a thermostat 9, and the like.

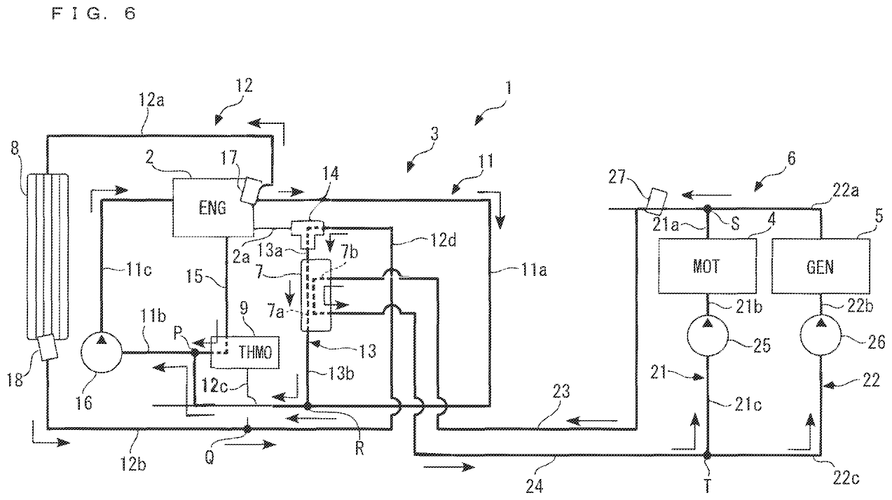

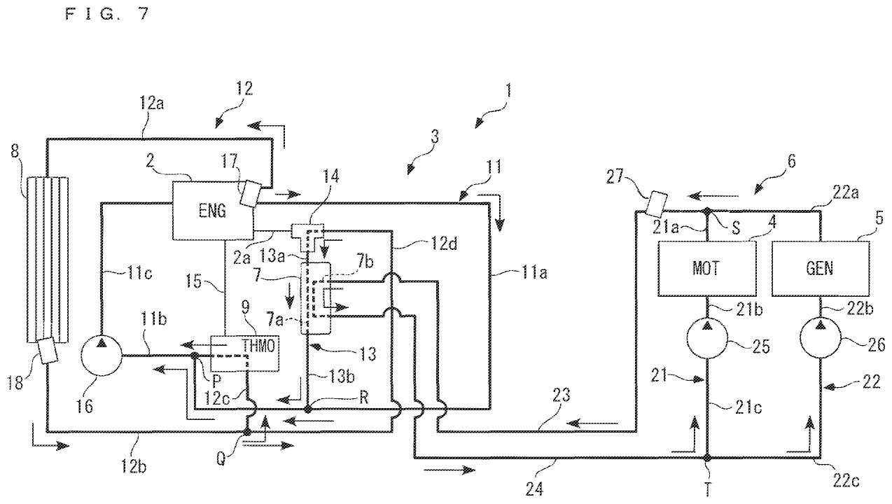

The main circuit 11 has a first flow path 11a, a second flow path 11b, and a third flow path 11c as flow paths through which coolant flows. Specifically, the first flow path 11a is connected to a coolant outflow port of a water jacket (not illustrated) of the engine 2, the second flow path 11b is provided to connect the thermostat 9 and a water pump 16, and the third flow path 11c is provided to connect the water pump 16 and a coolant inflow port of the water jacket. The first flow path 11a is also connected at a predetermined position (hereinafter referred to as a “connection position P”) in the middle of the second flow path 11b. The bypass flow path 15 is connected to the coolant outflow port of the water jacket of the engine 2. The thermostat 9 is opened and closed in accordance with the temperature of the coolant having flowed out of the engine 2 and having reached the thermostat 9 through the bypass flow path 15. Specifically, when the thermostat 9 is closed due to the coolant having a temperature lower than a predetermined temperature (for example, 90° C.), the second flow path 11b is in communication with the bypass flow path 15 (see FIG. 6, for example). In contrast, when the thermostat 9 is open due to the coolant having a temperature not less than the predetermined temperature, the second flow path 11b is in communication with a third flow path 12c of the radiator circuit 12 described below (see FIG. 7, for example). Note that although not illustrated, the first flow path 11a of the main circuit 11 is provided with a heater core or the like in use for heating inside the vehicle.

In the main circuit 11 having a configuration as above, when the water pump 16 is driven, the coolant having flowed out of the engine 2 circulates so as to flow into the engine 2 through the first flow path 11a, the second flow path 11b, and the third flow path 11c in order. In this case, when the thermostat 9 is closed due to the coolant having a temperature lower than the predetermined temperature, the coolant from the engine 2 also flows into the bypass flow path 15, and circulates so as to flow into the engine 2 through the second flow path 11b and the third flow path 11c in order.

The radiator circuit 12 has a first flow path 12a, a second flow path 12b, the third flow path 12c, and a fourth flow path 12d as flow paths through which coolant flows, and shares the second flow path 11b and the third flow path 11c of the main circuit 11. Specifically, the first flow path 12a is provided to connect the coolant outflow port of the water jacket of the engine 2 and the radiator 8, and one end of the second flow path 12b and one end of the third flow path 12c are connected together at a predetermined position (hereinafter referred to as a “connection position Q”), and the other end (upstream end) of the second flow path 12b is connected to the radiator 8 and the other end (downstream end) of the third flow path 12c is connected to the thermostat 9. The fourth flow path 12d has one end that is connected to the second flow path 12b and the third flow path 12c at the connection position Q and the other end that is connected to the three-way valve 14.

In the radiator circuit 12 having a configuration as above, when the water pump 16 is driven and the thermostat 9 opens, the coolant having flowed out of the engine 2 circulates so as to flow into the engine 2 through the first flow path 12a, the radiator 8, the second flow path 12b, the third flow path 12c, the thermostat 9, and the second flow path 11b and the third flow path 11c of the main circuit 11 in order. In this case, the thermostat 9 opens, so that the third flow path 12c of the radiator circuit 12 and the second flow path 11b of the main circuit 11 is in communication with each other, while the communication between the bypass flow path 15 and the second flow path 11b of the main circuit 11 is blocked. Thus, no coolant flows from the engine 2 into the bypass flow path 15. Note that the flow of the coolant in the fourth flow path 12d of the radiator circuit 12 will be described below.

The heat-exchange-coolant throughflow portion 13 has a first flow path 13a and a second flow path 13b as flow paths through which coolant flows. Specifically, the first flow path 13a is provided to connect the three-way valve 14 and the heat exchanger 7, and has one end that is connected to three-way valve 14 and the other end that is connected to a coolant flow path 7a within the heat exchanger 7. Meanwhile, the second flow path 13b is provided to connect the heat exchanger 7 and the first flow path 11a of the main circuit 11, and has one end that is connected to the coolant flow path 7a within the heat exchanger 7 and the other end that is connected at a predetermined position (hereinafter referred to as a “connection position R”) of the first flow path 11a.

In the heat-exchange-coolant throughflow portion 13 having a configuration as above, the coolant having flowed in the first flow path 13a through the three-way valve 14 flows into the first flow path of the main circuit 11 at the connection position R through the heat exchanger 7 and the second flow path 13b in order. During the coolant is flowing in the coolant flow path 7a within the heat exchanger 7, heat is exchanged between the coolant and the oil that is flowing in the oil flow path 7b.

In addition to the fourth flow path 12d of the radiator circuit 12 and the first flow path 13a of the heat-exchange-coolant throughflow portion 13 described above, an engine coolant flow path 2a provided to connect to the engine 2 is connected to the three-way valve 14. This engine coolant flow path 2a has one end that is closer to the engine 2 and is connected to the coolant outflow port of the water jacket of the engine 2, similarly to the first flow path 11a of the main circuit 11, the first flow path 12a of the radiator circuit 12, and the bypass flow path 15 described above.

As above, the three-way valve 14 selectively connects any two of the ends of the three flow paths, that is, the engine coolant flow path 2a, the fourth flow path 12d of the radiator circuit 12, and the first flow path 13a of the heat-exchange-coolant throughflow portion 13 with the ends connected to the three-way valve 14 itself.

The engine 2 is also provided with an engine coolant-temperature sensor 17 for detecting the temperature of the coolant that flows out of the water jacket (hereinafter referred to as “engine coolant temperature TW”). The radiator 8 is also provided with a radiator coolant-temperature sensor 18 for detecting the temperature of the coolant that is cooled with the radiator 8 and flows out of the radiator 8 (hereinafter referred to as “radiator coolant temperature TWR”). Note that the water pump 16 includes an electric pump, and regulates the flow rate of the coolant in accordance with the engine coolant temperature TW, the radiator coolant temperature TWR, or the like.

Meanwhile, the electric-system cooling circuit 6 has a motor flow path 21, a generator flow path 22, a feed flow path 23, and a return flow path 24 as flow paths through which the oil flows. Due to drive of a motor oil pump 25, the oil is supplied to the motor 4, and due to drive of a generator oil pump 26, the oil is supplied to the generator 5.

The motor flow path 21 has a first flow path 21a, a second flow path 21b, and a third flow path 21c. The first flow path 21a has one end that is connected to the feed flow path 23 at a connection position S and the other end that is connected to the oil outflow port of the motor 4. The second flow path 21b has one end that is connected to the oil inflow port of the motor 4 and the other end connected to the oil discharge port of the motor oil pump 25. The third flow path 21c has one end connected to the oil suction port of the motor oil pump 25 and the other end connected to the return flow path 24 at the connection position T.

Meanwhile, the generator flow path 22 has a first flow path 22a, a second flow path 22b, and a third flow path 22c. The first flow path 22a has one end connected to the feed flow path 23 at the connection position S and the other end connected to the oil outflow port of the generator 5. The second flow path 22b has one end connected to the oil inflow port of the generator 5 and the other end that is connected to the oil discharge port of the generator oil pump 26. The third flow path 22c has one end that is connected to the oil suction port of the generator oil pump 26 and the other end that is connected to the return flow path 24 at the connection position T.

The feed flow path 23 is a flow path for feeding the oil having flowed out of the motor 4 and the generator 5 to the heat exchanger 7, and has one end that is connected to the first flow path 21a of the motor flow path 21 and the first flow path 22a of the generator flow path 22 at the connection position S and the other end that is connected to the inflow port of the oil flow path 7b of the heat exchanger 7. On the other hand, the return flow path 24 is a flow path for returning the oil having flowed out of the heat exchanger 7 to the motor 4 and the generator 5, and has one end that is connected to the outflow port of the oil flow path 7b of the heat exchanger 7 and the other end that is connected to the third flow path 21c of the motor flow path 21 and the third flow path 22c of the generator flow path 22 at the connection position T.

In the electric-system cooling circuit 6 having a configuration as above, due to drive of at least one of the motor oil pump 25 and the generator oil pump 26, the oil having flowed out of the corresponding motor 4 or generator 5 flows to the connection position S through the corresponding first flow path 21a of the motor flow path 21 or first flow path 22a of the generator flow path 22. The oil having reached the connection position S flows to the connection position T through the feed flow path 23, the oil flow path 7b of the heat exchanger 7, and the return flow path 24 in order. The oil having reached the connection position T is sucked into the at least one of the motor oil pump 25 and the generator oil pump 26 through the corresponding third flow path 21c of the motor flow path 21 or third flow path 22c of the generator flow path 22. Then, the sucked oil is discharged from the at least one of the pump 25 and the pump 26 and supplied to the corresponding motor 4 or generator 5 through the corresponding second flow path 21b of the motor flow path 21 or second flow path 22b of the generator flow path 22. As above, in the case of the oil that circulates through the electric-system cooling circuit 6, when the oil is flowing in the oil flow path 7b within the heat exchanger 7, heat is exchanged between the oil and the coolant that is flowing in the coolant flow path 7a.

An oil temperature sensor 27 for detecting the temperature of the oil having passed the connection position S (hereinafter referred to as “oil temperature TATF”) is provided at a predetermined position of the feed flow path 23 of the electric-system cooling circuit 6. Note that the motor oil pump 25 and the generator oil pump 26 each include an electric pump, and the flow rate of the oil is regulated in accordance with the oil temperature TATF or the like.

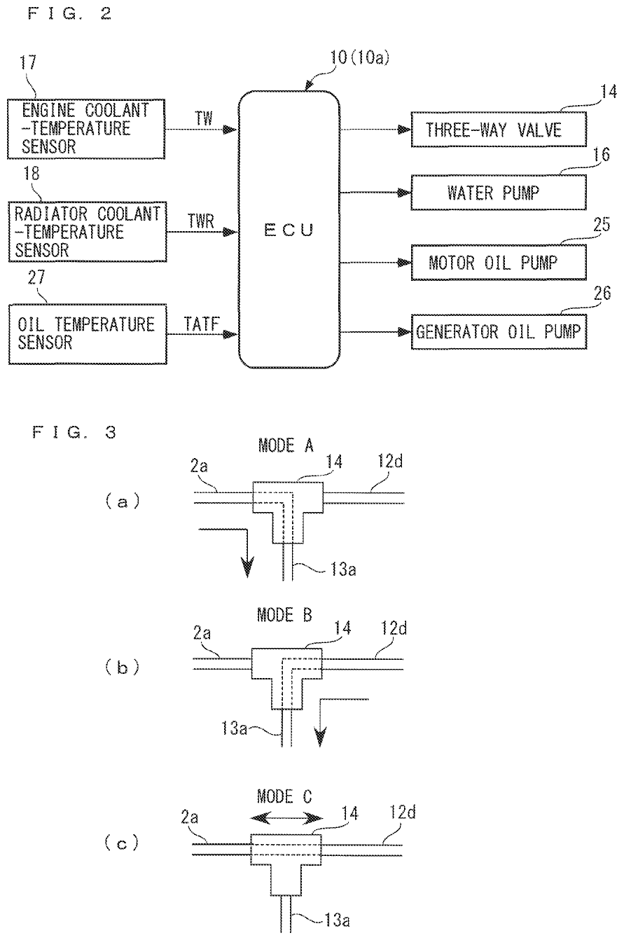

FIG. 2 illustrates a control unit 10 in the cooling apparatus 1. The control unit 10 includes an electronic control unit (ECU) 10a. This ECU 10a serves as a microcomputer including a control processing unit (CPU), a random access memory (RAM), a read only memory (ROM), an I/O interface (all not illustrated), and the like. Detection signals of the engine coolant temperature TW detected by the engine coolant-temperature sensor 17, the radiator coolant temperature TWR detected by the radiator coolant-temperature sensor 18, and the oil temperature TATF detected by the oil temperature sensor 27 are output to the ECU 10a. The ECU 10a controls the three-way valve 14, the water pump 16, the motor oil pump 25, the generator oil pump 26, and the like in accordance with these detection signals and the like.

FIG. 3 illustrates a switching state of a flow path of coolant by three-way valve 14. FIG. 3(a) illustrates that the engine coolant flow path 2a is in connection with the first flow path 13a of the heat-exchange-coolant throughflow portion 13. FIG. 3(b) illustrates that the fourth flow path 12d of the radiator circuit 12 is in connection with the first flow path 13a of the heat-exchange-coolant throughflow portion 13. FIG. 3(c) illustrates that the engine coolant flow path 2a is in connection with the fourth flow path 12d of the radiator circuit 12. Note that in the following description, the above switching states of the flow paths illustrated in FIGS. 3(a), 3(b), and 3(c) will be appropriately referred to as “mode A”, “mode B”, and “mode C”, respectively.

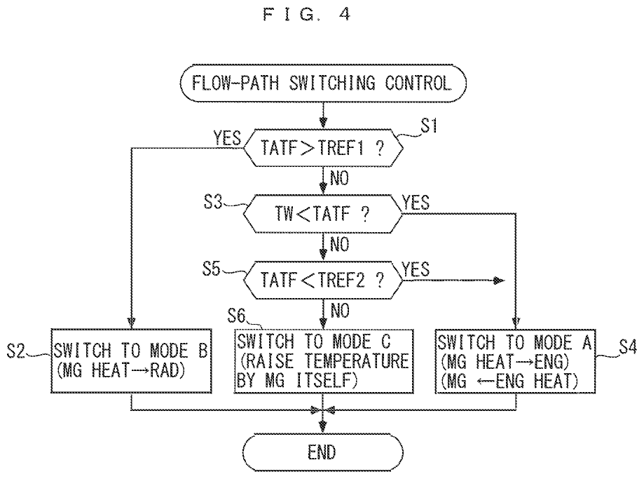

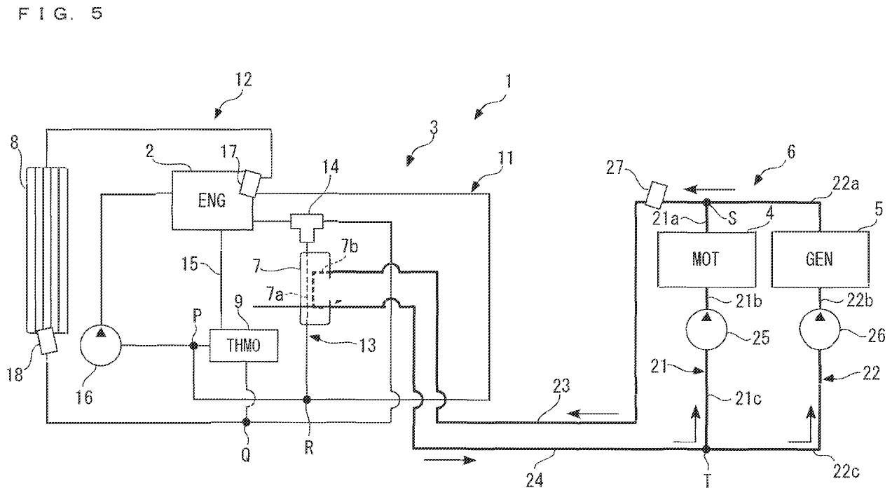

Next, coolant flow-path switching control by the three-way valve 14 will be described with reference to FIGS. 4 to 11. FIG. 4 is a flowchart illustrating flow-path switching control processing, which is performed in the ECU 10a at predetermined time intervals. FIG. 5 explanatorily illustrates that the flow of the coolant of the engine cooling circuit 3 is stopped and only the oil in the electric-system cooling circuit 6 is flowing. Note that in the cooling circuit diagrams in FIGS. 6 to 11 described below, similarly in FIG. 5, the directions in which the oil and the coolant are flowing are indicated by arrows, the flow paths in which the oil and the coolant are flowing are indicated by thick lines, and the flow paths in which no oil and coolant are flowing are indicated by thin lines.

As illustrated in FIG. 4, in this flow-path switching control processing, first, in Step 1 (illustrated as “S1”, the same applies hereinafter), it is determined whether or not the oil temperature TATF is larger than a first threshold TREF1. The first threshold TREF1 is set at a relatively high value (for example, 100° C.) as a threshold for determining that the heat of the electric-system cooling circuit 6 is to be discharged to the outside because the temperature of at least one of the motor 4 and the generator 5 increases and its oil temperature TATF increases. When the determination result in Step 1 is YES, the flow proceeds to Step 2, the three-way valve 14 is switched to mode B (including the maintenance of mode B), and this processing ends.

FIG. 6 illustrates that the three-way valve 14 is switched to mode B, that is, the fourth flow path 12d of the radiator circuit 12 and the first flow path 13a of the heat-exchange-coolant throughflow portion 13 are connected together and the water pump 16 is driven. FIG. 6 also illustrates that the thermostat 9 is closed because the engine 2 has not been warmed up yet and the temperature of the coolant is low. As illustrated in FIG. 6, in this case, in the engine cooling circuit 3, the coolant flows and circulates clockwise through the main circuit 11 in FIG. 6 and the coolant also flows into the bypass flow path 15 and circulates, and the coolant further flows and circulates through the radiator circuit 12 as below.

That is, the coolant having flowed out of the engine 2 first flows through the first flow path 12a of the radiator circuit 12, the radiator 8, and the second flow path 12b and the fourth flow path 12d of the radiator circuit 12 in order, and reaches the three-way valve 14. Next, the coolant having reached the three-way valve 14 flows through the first flow path 13a of the heat-exchange-coolant throughflow portion 13, the coolant passage 7a of the heat exchanger 7, and the second flow path 13b of the heat-exchange-coolant throughflow portion 13, and reaches the connection position R where the second flow path 13b is connected to the first flow path 11a of the main circuit 11. Then, the coolant having reached the connection position R joins the coolant circulating in the main circuit 11, flows through the second flow path 11b and the third flow path 11c of the main circuit 11 in order, and flows into the engine 2.

In such circulation of the coolant through the radiator circuit 12 as above, the coolant with the lowest temperature having flowed out of the radiator 8 is introduced into the heat exchanger 7. As a result, the heat of the oil having a relatively higher temperature is transferred to the coolant and the coolant flows into the radiator 8. The coolant is cooled by heat dissipation. That is, the heat of the at least one of the motor 4 and the generator 5 generated due to its operation can be discarded to the outside through the radiator 8. Note that in the parentheses in Step 2 of FIG. 4, the motor 4 and the generator 5 are denoted with “MG”, the radiator 8 is denoted with “RAD”, and the direction of heat transfer is indicated by an arrow (MG heat→RAD).

Note that FIG. 7 illustrates the flow of the coolant when the thermostat 9 opens in the state of FIG. 6 described above. As illustrated in FIG. 7, when the thermostat 9 opens, the coolant having flowed out of the radiator 8 branches at the connection position Q, flows into the third flow path 12c of the radiator circuit 12 as a main flow path, and a portion of the coolant flows into the fourth flow path 12d. Then, the coolant having flowed in the third flow path 12c flows into the engine 2 through the thermostat 9, and the second flow path 11b and the third flow path 11c of the main circuit 11. Meanwhile, the coolant having flowed in the fourth flow path 12d passes the heat-exchange-coolant throughflow portion 13; joins, at the connection position R, the coolant flowing through the first flow path 11a of the main circuit 11; and further joins, at the connection position P, the coolant having branched at the connection position Q.

Referring back to FIG. 4, when the determination result in Step 1 is NO and the following expression is satisfied: TATF≤TREF1, it is determined whether or not the engine coolant temperature TW is lower than the oil temperature TATF (Step 3). When the determination result is YES, the flow proceeds to Step 4, the three-way valve 14 is switched to mode A (including the maintenance of mode A), and this processing ends.

Otherwise, when the determination result in Step 3 is NO and the following expression is satisfied: TATF≤TW, it is determined whether or not the oil temperature TATF is lower than a second threshold TREF2 (Step 5). The above second threshold TREF2 is set at a relatively low value (for example, 50° C.) as a threshold for determining that the at least one of the motor 4 and the generator 5 is to be raised in temperature for its efficient operation because the temperature of the at least one of the motor 4 and the generator 5 decreases and its oil temperature TATF decreases. When the determination result in Step 5 is YES, the flow proceeds to Step 4 described above, the three-way valve 14 is switched to mode A (including the maintenance of mode A), and this processing ends.

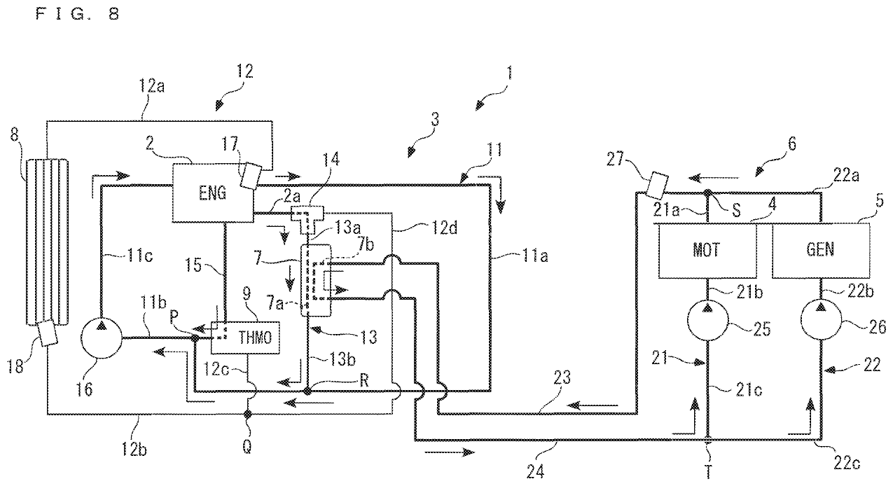

FIG. 8 illustrates that the three-way valve 14 is switched to mode A, that is, the engine coolant flow path 2a and the first flow path 13a of the heat-exchange-coolant throughflow portion 13 are connected together, the water pump 16 is driven, and the thermostat 9 is closed. As illustrated in the figure, in this case, similarly to the case described in FIG. 6, in the engine cooling circuit 3, the coolant flows and circulates in the main circuit 11 and the bypass flow path 15. The coolant having flowed out of the engine 2 and reached the three-way valve 14 through the engine coolant flow path 2a flows through the heat-exchange-coolant throughflow portion 13 and is introduced into the heat exchanger 7, similarly to the case described in FIG. 6. Note that as above, the coolant having reached the connection position R joins the coolant circulating in the main circuit 11, flows through the second flow path 11b and the third flow path 11c in order, and flows into the engine 2.

As above, in a case where the coolant reaches the three-way valve 14 through the engine coolant flow path 2a, the coolant with the highest temperature having flowed out of the engine 2 is introduced into the heat exchanger 7. When the determination result in Step 3 in FIG. 4 is YES, that is, the engine coolant temperature TW is lower than the oil temperature TATF, and in a case where the three-way valve 14 is switched to mode A, the heat of the oil having a relatively high temperature transfers to the coolant in the heat exchanger 7 and the coolant flows into the engine 2, so that the engine 2 is raised in temperature. That is, when the heat of the at least one of the motor 4 and the generator 5 can be given to the engine 2 and the engine 2 has not been warmed up yet, the engine 2 can be warmed up speedily. In the parentheses in Step 4 of FIG. 4, the engine 2 is denoted with “ENG”, and the heat transfer between the engine 2 and the motor 4 and between the engine 2 and the generator 5 is indicated by an arrow (MG heat→ENG).

When the determination result in Step 3 is NO and the determination result in Step 5 is YES, that is, in a case where the three-way valve 14 is switched to mode A because the oil temperature TATF is not more than the engine coolant temperature TW (TATF≤TW) and is lower than the second threshold TREF2 (TATF<TREF2), when the engine coolant temperature TW is higher than the oil temperature TATF, the heat of the coolant having a relatively higher temperature is transferred to the oil, in the heat exchanger 7 and the oil flows into the corresponding motor 4 or generator 5, so that its temperature is raised. That is, when the heat of the engine 2 can be given to the corresponding motor 4 or generator 5 (MG←ENG heat) and its temperature is lower than the temperature range for its efficient operation, the corresponding motor 4 or generator 5 can be quickly raised in temperature and operated efficiently.

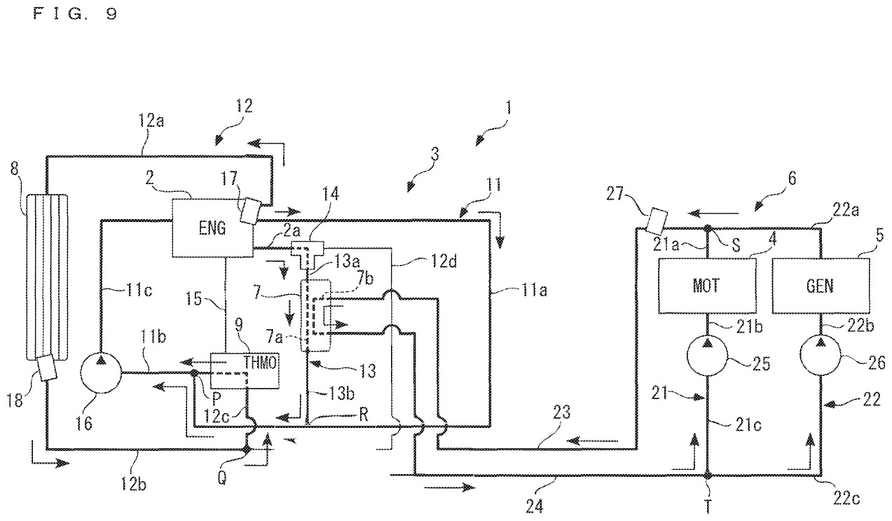

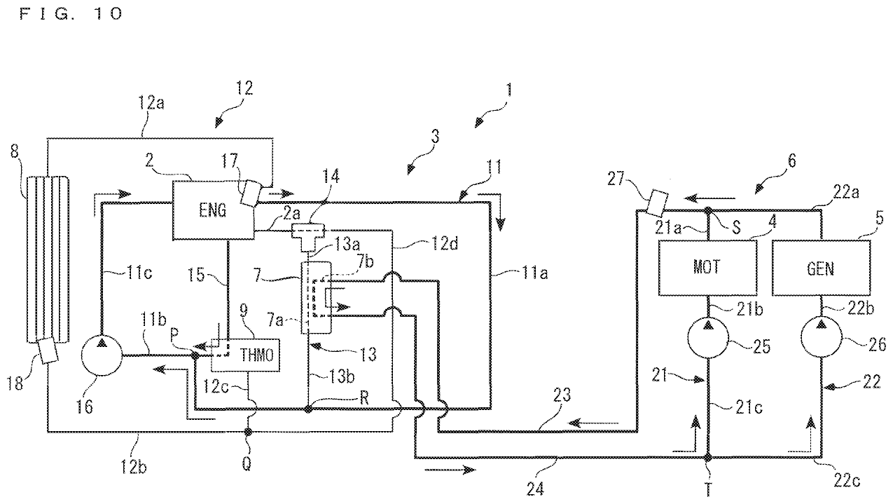

Note that FIG. 9 illustrates the flow of the coolant when the thermostat 9 opens in the state of FIG. 8 described above. As illustrated in FIG. 9, in the radiator circuit 12, when the thermostat 9 opens, a portion of the coolant having flowed out of the engine 2 flows into the radiator 8 and is cooled by heat dissipation. The coolant passes the second flow path 12b and the third flow path 12c of the radiator circuit 12 and the thermostat 9 in order; joins, at the connection position P, the coolant having flowed through the first flow path 11a of the main circuit 11; and flows into the engine 2 through the second flow path 11b and the third flow path 11c of the main circuit 11.

Referring back to FIG. 4, when the determination result in Step 5 is NO, that is, in a case where the oil temperature TATF is not less than the second threshold TREF2 and is not less than the lower limit within the temperature range for efficient operation of the corresponding motor 4 or generator 5 and is not in a sufficient state of actively raising its temperature, the three-way valve 14 is switched to mode C (including the maintenance of mode C), and this processing ends.

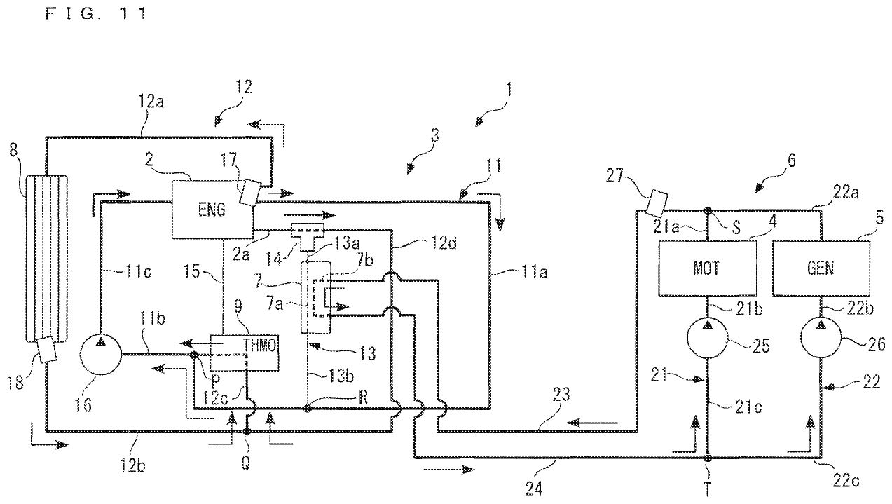

FIG. 10 illustrates that the three-way valve 14 is switched to mode C, that is, the engine coolant passage 2a and the fourth flow path 12d of the radiator circuit 12 are connected together, the water pump 16 is driven, and the thermostat 9 is closed. As illustrated in FIG. 10, in this case, in the engine cooling circuit 3, the coolant flows and circulates through the main circuit 11 and the bypass flow path 15. That is, no coolant flows into the radiator circuit 12 and the engine coolant flow path 2a, and thus no coolant flows into the heat-exchange-coolant throughflow portion 13 and is introduced into the heat exchanger 7. As a result, the oil of the electric-system cooling circuit 6 circulates without being subjected to heat exchange. Thus, when the corresponding motor 4 or generator 5 is in operation, its temperature is raised due to heat generation by itself (raising temperature by MG itself), together with the temperature of the oil in circulation.

Note that FIG. 11 illustrates the flow of the coolant when the thermostat 9 is open in the state of FIG. 10 described above. As illustrated in FIG. 11, in the radiator circuit 12, when the thermostat 9 opens, a portion of the coolant having flowed out of the engine 2 flows into the radiator 8 and is cooled by heat dissipation, and reaches the connection position Q through the second flow path 12b of the radiator circuit 12. Another portion of the coolant having flowed out of the engine 2 reaches the connection position Q through the engine coolant flow path 2a, the three-way valve 14, and the fourth flow path 12d of the radiator circuit 12. Then, these portions of the coolant having reached the connection position Q join. The joined coolant passes the third flow path 12c of the radiator circuit 12 and the thermostat 9; joins, at the connection position P, the coolant circulating in the main circuit 11; and flows into the engine 2 through the second flow path 11b and the third flow path 11c of the main circuit 11.

As described above in detail, according to the present embodiment, switching a flow path of coolant by the three-way valve 14 in accordance with the engine coolant temperature TW and the oil temperature TATF enables effective heat exchange between the coolant of the engine cooling circuit 3 and the oil of the electric-system cooling circuit 6 and enables the engine 2, the motor 4, and the generator 5 to be cooled and raised in temperature appropriately and speedily.

Note that the present invention is not limited to the above embodiment, and thus may be carried out in various aspects. For example, in the embodiment, the motor 4 and the generator 5 are exemplified as the electric-system devices to be cooled in the electric-system cooling circuit 6. The present invention, however, is not limited thereto, and thus various devices (for example, a battery) that may have relatively high heat can be the above electric-system devices. In addition, in the embodiment, the three-way valve 14 is adopted as the flow-path switch of the present invention. The present invention, however, is not limited thereto, and thus various switching valves capable of appropriately switching a flow path can be adopted. Furthermore, the detailed configurations and the like of the cooling apparatus 1, the engine cooling circuit 3, and the electric-system cooling circuit 6 described in the embodiment are merely examples, and thus may be appropriately changed within the scope of the gist of the present invention.

### REFERENCE SIGNS LIST

1 cooling apparatus

2 internal combustion engine

2a engine coolant flow path (first flow path)

3 engine cooling circuit

4 motor (electric-system device)

5 generator (electric-system device)

6 electric-system cooling circuit

7 heat exchanger

7a coolant flow path within heat exchanger

7b oil flow path within heat exchanger

8 radiator

9 thermostat

10 control unit

10a ECU (three-way-valve control means)

11 main circuit

12 radiator circuit

12d fourth flow path (second flow path) of radiator circuit

13 heat-exchange-coolant throughflow portion

14 three-way valve (flow-path switch)

16 water pump

17 engine coolant-temperature sensor (coolant temperature detection means)

18 radiator coolant-temperature sensor

21 motor flow path of electric-system cooling circuit

22 generator flow path of electric-system cooling circuit

23 feed flow path

24 return flow path

25 motor oil pump

26 generator oil pump

27 oil temperature sensor (refrigerant temperature detection means)

TW engine coolant temperature

TATF oil temperature

TREF1 first threshold

TREF2 second threshold

1. A cooling apparatus for a hybrid vehicle, the cooling apparatus comprising: an engine cooling circuit configured to circulate coolant for cooling an internal combustion engine; an electric-system cooling circuit configured to circulate refrigerant for cooling an electric-system device; and a heat exchanger configured to perform heat exchange between the coolant and the refrigerant each flowing through the heat exchanger,
wherein the engine cooling circuit includes:
a main circuit enabling continuous circulation of the coolant through the main circuit;
a radiator circuit including a radiator for cooling the coolant and configured to circulate the coolant between the internal combustion engine and the radiator;
a heat-exchange-coolant throughflow portion having the heat exchanger, enabling the coolant to flow through the heat-exchange-coolant throughflow portion, and configured to return the coolant having flowed out through the heat exchanger to the main circuit; and
a flow-path switch provided at an upstream end of the heat-exchange-coolant throughflow portion, the flow-path switch being capable of switching a flow path of the coolant such that the coolant having flowed out of either the internal combustion engine or the radiator is allowed to flow into the heat exchanger.

2. The cooling apparatus for a hybrid vehicle according to claim 1, wherein the flow-path switch is capable of switching the flow path of the coolant such that the coolant having flowed out of each of the internal combustion engine and the radiator is blocked from flowing into the heat exchanger.

3. The cooling apparatus for a hybrid vehicle according to claim 2, wherein the flow-path switch includes a three-way valve capable of selectively connecting any two ends of a downstream end of a first flow path through which the coolant having flowed out of the internal combustion engine flows, a downstream end of a second flow path through which the coolant having flowed out of the radiator flows, and the upstream end of the heat-exchange-coolant throughflow portion.

4. The cooling apparatus for a hybrid vehicle according to claim 3, further comprising:
a refrigerant temperature detection means for detecting a temperature of the refrigerant of the electric-system cooling circuit; and
a three-way-valve control means for controlling the three-way valve,
wherein when the temperature of the refrigerant detected is higher than a predetermined first threshold, the three-way-valve control means controls the three-way valve such that the downstream end of the second flow path and the upstream end of the heat-exchange-coolant throughflow portion are connected together.

5. The cooling apparatus for a hybrid vehicle according to claim 4, further comprising:
a coolant temperature detection means for detecting a temperature of the coolant of the engine cooling circuit,
wherein when the temperature of the coolant detected is lower than the temperature of the refrigerant detected, or when the temperature of the refrigerant is not more than the temperature of the coolant and is lower than a predetermined second threshold lower than the first threshold, the three-way-valve control means controls the three-way valve such that the downstream end of the first flow path and the upstream end of the heat-exchange-coolant throughflow portion are connected together.

6. The cooling apparatus for a hybrid vehicle according to claim 5, wherein when the temperature of the refrigerant detected is not less than the second threshold, the three-way-valve control means controls the three-way valve such that the downstream end of the first flow path and the downstream end of the second flow path are connected together.

7. The cooling apparatus for a hybrid vehicle according to claim 1, wherein the electric-system device includes at least one of a motor and a generator.
